(19) United States
(12) Patent Application Publication
(10) Pub. No.: US 2021/0133833 A1
(43) Pub. Date: May 6, 2021

(54) INFORMATION PROCESSING DEVICE, INFORMATION PROCESSING METHOD, AND PROGRAM

(71) Applicant: Bank Invoice Corporation, Tokyo (JP)

(72) Inventor: Taro Teshima, Tokyo (JP)

(21) Appl. No.: 17/140,069

(22) Filed: Jan. 2, 2021

Related U.S. Application Data
(63) Continuation of application No. PCT/JP2019/026341, filed on Jul. 2, 2019.

(30) Foreign Application Priority Data
Jul. 3, 2018 (JP) 2018-126525

(51) Int. Cl. G06Q 30/04; H04L 9/06; G06F 16/182

(52) U.S. Cl. CPC G06Q 30/04; H04L 2209/38; G06F 16/1834; H04L 9/0618

(57) ABSTRACT

An invoice management apparatus includes an invoice data storage unit that stores therein, upon receipt of business document data addressed to a specified recipient from a terminal device over a network, the received business document data in association with the identification information of the recipient and issuer of the business document data, and a transaction data generation unit that determines whether at least one of the number of times a status indicating the processing progress of the business document data communicated between the issuer and the recipient has been changed and the number of times data accompanying the business document data has been changed has reached a prescribed number of times, and when the prescribed number of times has been reached, collects the business document data and the data accompanying the business document data and sends the collected business document data and data to databases that perform consensus building.

### RELATED APPLICATIONS

This application claims priority under 35 U.S.C. § 120 to, and is a continuation of, co-pending International Application PCT/JP2019/26341, filed Jul. 2, 2019 and designating the US, which claims priority to JP Application 2018-1265251, filed Jul. 3, 2018, such JP Application also being claimed priority to under 35 U.S.C. § 119. These JP and International applications are incorporated by reference herein in their entireties.

### BACKGROUND

### Field

The embodiment discussed herein relates to an information processing apparatus and an information processing method.

There is known a technique for achieving unified management for viewing of business documents (for example, invoices and others) of an entire company or an entire corporate group and information thereof.

For example, there is known an information processing apparatus that has a first storage unit that stores therein user information associating user identification information identifying a user and at least one piece of unique information with each user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

In addition, for example, a blockchain has been known as a method for preventing business document information from being falsified. In the blockchain, so-called mining is performed at fixed time intervals for consensus building.

Please see, for example, International Publication Pamphlet No. WO 2015/049948.

### SUMMARY

According to one aspect, there is provided an invention processing apparatus including: a memory that stores therein, upon receipt of business document data addressed to a specified recipient from a terminal device over a network, the received business document data in association with identification information of the recipient and identification information of an issuer of the business document data; and a processor that is coupled to the memory and is configured to perform a process including determining whether at least one of a number of times a status indicating a processing progress of the business document data communicated between the issuer and the recipient has been changed and a number of times data accompanying the business document data has been changed has reached a prescribed number of times, and collecting, in response to the prescribed number of times having been reached, the business document data and the data accompanying the business document data and sending the collected business document data and data to a plurality of consensus building devices that perform consensus building.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to a first embodiment;

FIG. 2 is a view for explaining an example of a screen that is displayed on a terminal device after a login;

FIG. 3 illustrates a hardware configuration of an invoice management apparatus according to the embodiment;

FIG. 4 is a block diagram illustrating functions of the invoice management apparatus according to the embodiment;

FIG. 5 is a view for explaining an example of invoice data;

FIG. 6 is a view for explaining information that is displayed in a summary display area;

FIGS. 7A and 7B are views for explaining information that is displayed in the summary display area;

FIG. 8 is a view for explaining an example of external communication data;

FIG. 9 is a view for explaining an example of attached file data;

FIG. 10 is a view for explaining an example of history data;

FIG. 11 is a view for explaining an example of memo data;

FIG. 12 is a block diagram for explaining functions of a database according to the embodiment; and

FIG. 13 illustrates an example of information contained in a blockchain according to the embodiment.

### DETAILED DESCRIPTION

Hereinafter, an invoice management system according to one embodiment will be described in detail with reference to the accompanying drawings.

### First Embodiment

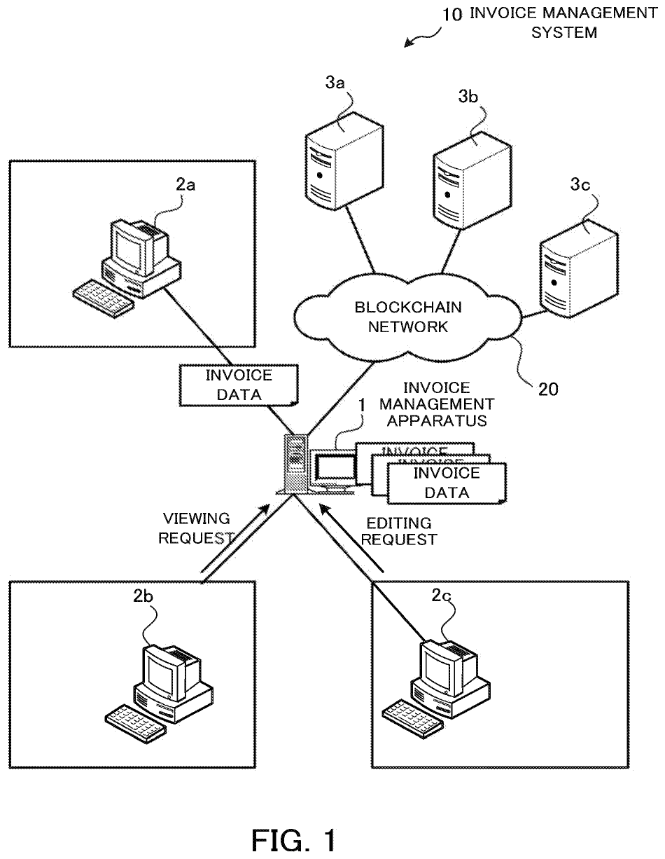

FIG. 1 illustrates an invoice management system according to a first embodiment.

In the invoice management system 10 of the first embodiment, an invoice management apparatus 1 is connected to terminal devices 2a, 2b, and 2c over the Internet or a dedicated network.

The terminal devices 2a, 2b, and 2c are placed at accounting departments of different companies. For example, the terminal device 2a is placed at a company A, the terminal device 2b is placed at a company B, and the terminal device 2c is placed at a company C. Examples of the terminal devices 2a, 2b, and 2c include desktop personal computers, laptop personal computers, tablet terminals, and smartphones.

A web program is installed in the invoice management apparatus 1 and the terminal devices 2a, 2b, and 2c. The terminal devices 2a, 2b, and 2c communicate invoice data on invoices with the invoice management apparatus 1 through Web browsers. In this connection, the present embodiment explains communication of invoice data, but invoices are an example of business documents and the present embodiment is not limited thereto. Other examples of business documents include estimate forms and order forms.

The invoice management apparatus 1 outputs information (the hash of a file, or others) to be written in a blockchain to the network. In this embodiment, the information to be written includes invoice data and data accompanying the invoice data.

The databases 3a, 3b, and 3c are connected to each other with a blockchain network 20.

Each database 3a, 3b, and 3c generates a unique, irreversible, and random hash function on the basis of some data.

Hereinafter, it is assumed that the invoice management system 10 is used by the individual accounting personnel of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel of the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting personnel are able to operate their terminal devices 2a, 2b, and 2c to process invoice data, which is a digitized version of original invoices, via the invoice management apparatus 1. The processing of invoice data includes creation, sending, receipt, viewing, editing, and others.

For example, when the accounting personnel of the company A issues an invoice to the company B, the accounting personnel of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, and 2c. Rather, all invoice data created by the terminal devices 2a, 2b, and 2c and sent to bill-to parties is held by the invoice management apparatus 1. The invoice data is treated like shared data. The invoice management apparatus 1 gives viewing and editing authorities for the invoice data to the terminal devices 2a, 2b, and 2c according to necessity.

The above approach makes it possible to digitize and process original invoices electronically, which leads to saving labor for management and storage of paper- or PDF-based invoices.

As described earlier, invoice data is not communicated directly between the terminal devices 2a, 2b, and 2c. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c.

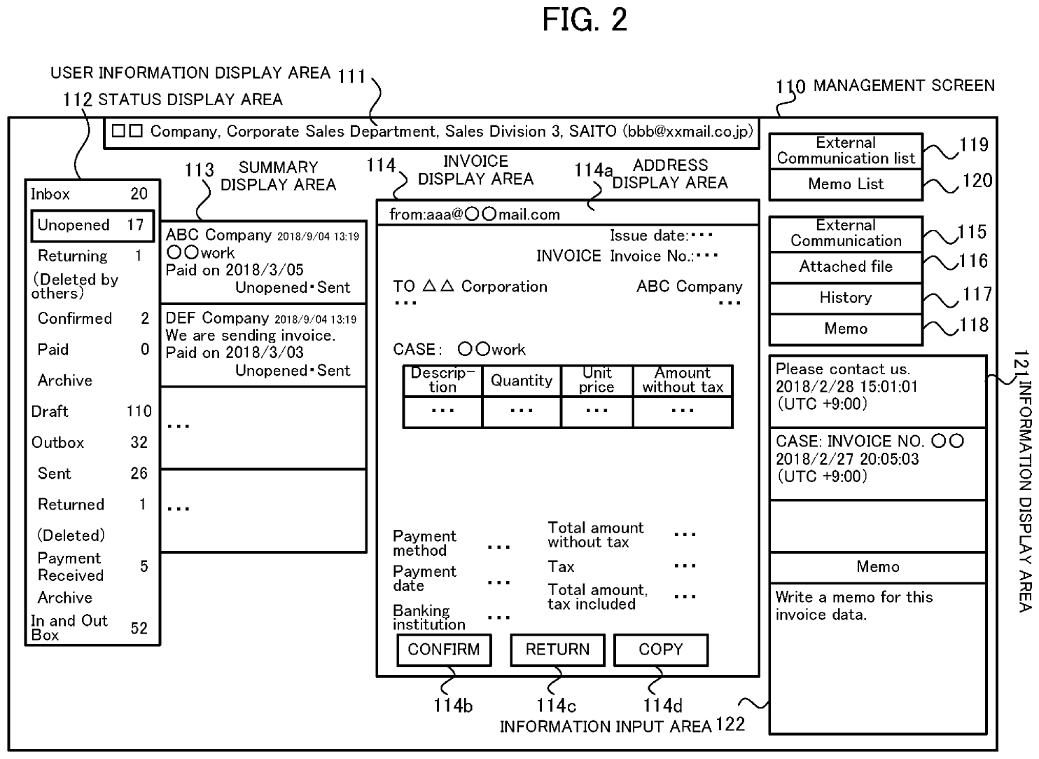

FIG. 2 is a view for explaining an example of a screen that is displayed on a terminal device after a login.

The management screen 110 illustrated in FIG. 2 is an example of a screen that is displayed on the terminal device 2a.

As illustrated in FIG. 2, an accounting personnel is able to create, issue, view, and edit invoice data, like he/she uses mail software.

By the way, in the above-described example, the accounting personnel of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

When the communication (transaction) of new invoice data occurs, the invoice management apparatus 1 sends the transaction details to the databases 3a, 3b, and 3c. The managers of the databases 3a, 3b, and 3c refer to their own databases to confirm whether the transaction of the new invoice data is not fraudulent.

Then, consensus building is performed to determine an update authority for the databases. Examples of a method for the consensus building include power of work, proof of stake, and others.

For example, when the manager of the database 3a is the first that has found a solution, the manager of the database 3a notifies the participants of the other databases 3b and 3c of the solution finding.

At this time, a reward may be given to the manager of the database 3a.

The managers of the databases 3a, 3b, and 3c add the transaction data notified of by the invoice management apparatus 1 to their own databases.

Now, the disclosed invoice management system will be described more concretely.

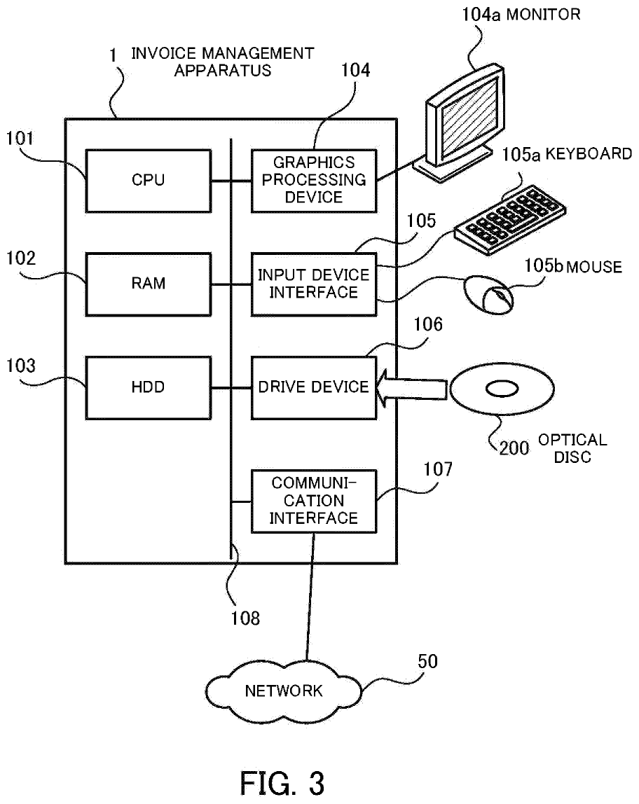

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of an OS (operating system) program and an application program that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. An OS program, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on an optical disc 200 may be read with laser light or the like. Examples of the optical disc 200 include Blu-ray (registered trademark), DVD (digital versatile disc), DVD-RAM, CD-ROM (compact disc read only memory), CD-R (recordable), and CD-RW (rewritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 functions described below.

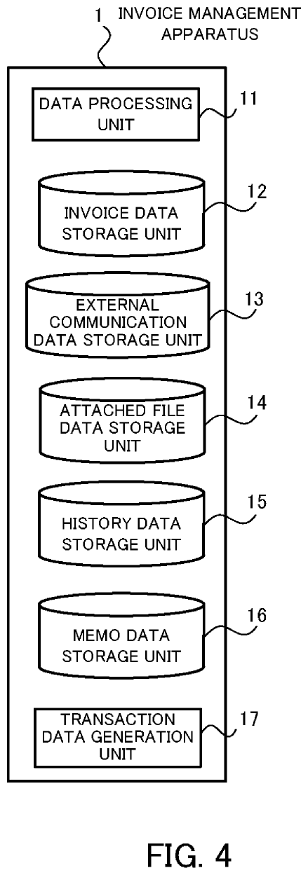

FIG. 4 is a block diagram illustrating functions of the invoice management apparatus according to the present embodiment.

The invoice management apparatus 1 has a data processing unit 11, an invoice data storage unit 12, an external communication data storage unit 13, an attached file data storage unit 14, a history data storage unit 15, a memo data storage unit 16, and a transaction data generation unit 17.

The data processing unit 11 displays the management screen 110 illustrated in FIG. 2 on the terminal device 2a or the like in accordance with accounting personnel's operations. The data processing unit 11 performs appropriate processing according to operations made to invoice data on the management screen 110. For example, the data processing unit 11 classifies and stores invoice data received by the invoice management apparatus 1, external communications (to be described later) and memos made by an accounting personnel, and others in appropriate storage units.

The invoice data storage unit 12 stores therein invoice data received by the invoice management apparatus 1, by accounting personnel (more specifically, by mail address of accounting personnel). The invoice data received by the invoice management apparatus 1 includes invoice data sent from the accounting personnel of billers to the accounting personnel of bill-to parties and invoice data drafted by the accounting personnel (issuers) of the billers

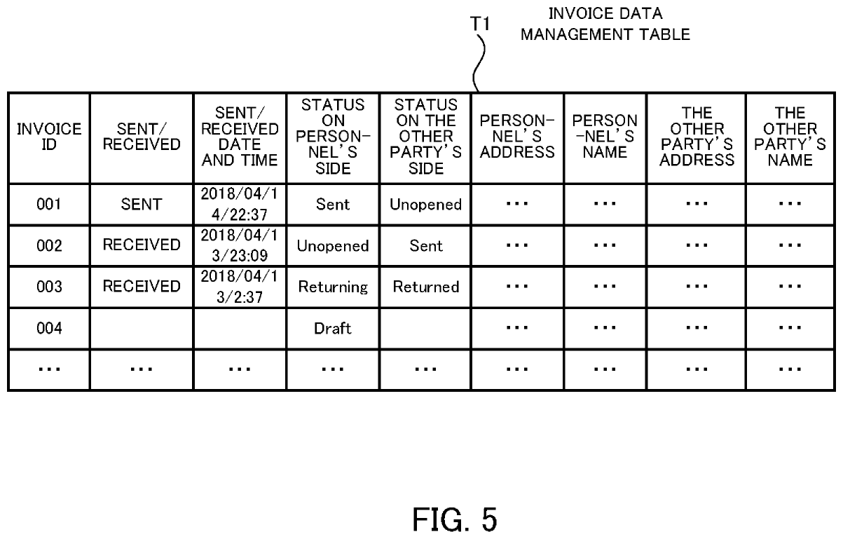

FIG. 5 is a view for explaining an example of invoice data.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's Address, Personnel's Name, the Other Party's Address, and the Other Party's Name. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Address column contains the mail address of the accounting personnel.

The Personnel's Name column contains the name of the accounting personnel.

The Other Party's Address column contains the mail address of the accounting personnel of the other party that communicates the invoice data.

The Other Party's Name column contains the name of the other party that communicates the invoice data.

In addition to the illustrated information, the invoice data management table contains data on invoices, including the company name and department name of the accounting personnel, the company name and department name of the accounting personnel of the other party that communicates the invoice data, the postal codes and addresses of the individual companies, breakdown items, and a billing amount.

The following describes a management screen.

### (Management Screen)

The data processing unit 11 displays the management screen 110 illustrated in

FIG. 2 on the terminal device 2a or the like in accordance with accounting personnel's operations.

The management screen 110 has a user information display area 111, a status display area 112, a summary display area 113, an invoice display area 114, an External Communication button 115, an Attached File button 116, a History button 117, a Memo button 118, an External Communication List button 119, a Memo List button 120, an information display area 121, and an information input area 122.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the biller among the invoice data placed in the Inbox folder.

The “Deleted by the Other Party” status is given by the data processing unit 11 to invoice data that has been received, returned by the accounting personnel to the accounting personnel of the biller, and then deleted by the accounting personnel of the biller, among the invoice data placed in the Inbox folder.

The “Confirmed” status is given by the data processing unit 11 to invoice data which the accounting personnel has viewed and for which the accounting personnel has selected a Confirm button (to be described later), among the invoice data placed in the Inbox folder.

The “Paid” status is given by the data processing unit 11 to invoice data for which the accounting personnel has made payment and then selected a Payment button, not illustrated, among the invoice data placed in the Inbox folder.

The accounting personnel compiles the invoice data in the Paid status to confirm the details of the payment.

The “Archive” status is given by the data processing unit 11 to invoice data which the account personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the contents of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the biller, among the invoice data returned from the accounting personnel of the bill-to party.

The “Payment Received” status is given by the data processing unit 11 to invoice data for which the accounting personnel of the biller has confirmed payment and selected a Payment Received button, not illustrated, among the invoice data placed in the Outbox folder.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the contents of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a biller, a case name, a payment due, a status on the sender side, and a status on the recipient side.

The same statuses are displayed on the management screens of both the accounting personnel who has sent invoice data and the accounting personnel who has received the invoice data.

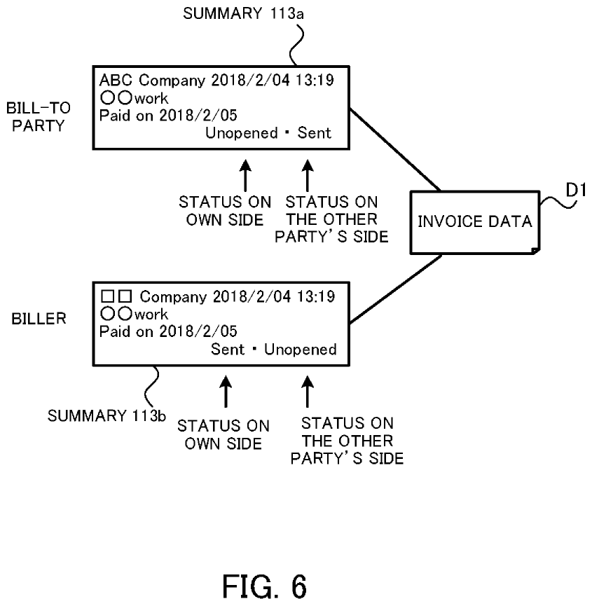

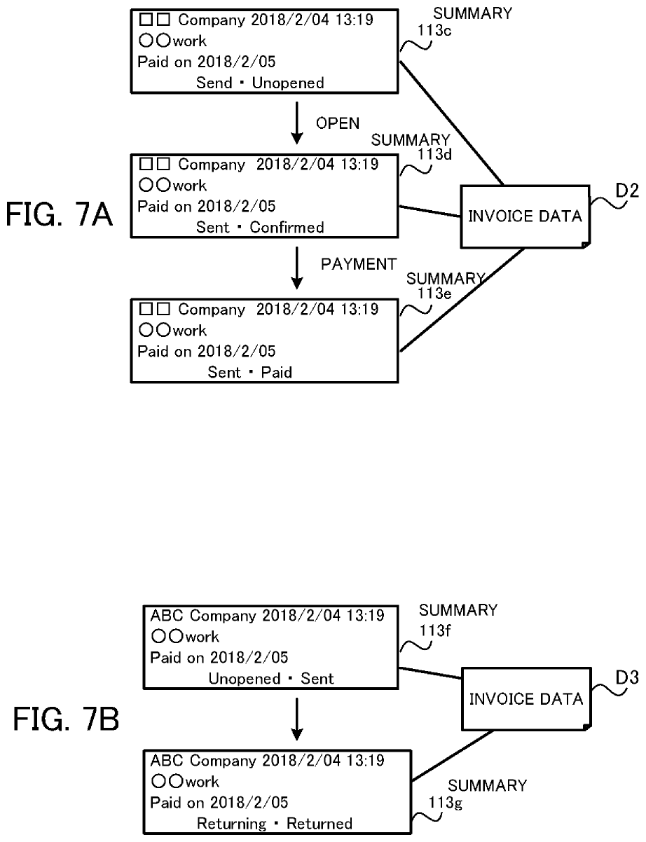

FIGS. 6, 7A, and 7B are views for explaining information that is displayed in the summary display area.

FIG. 6 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the biller.

More specifically, invoice data D1 with a biller of ABC company and a case name of OO work, as illustrated in FIG. 6, is in the “Sent” status in the status display area on the management screen of the terminal device operated by the accounting personnel of the biller. When the accounting personnel of the biller selects the “Sent” status in the status display area, the following information is displayed with respect to the invoice data D1 in the summary display area 113: a bill-to party is □□ company, a case name is OO work, a status on the accounting personnel's side of the biller is “Sent,” and a status on the accounting personnel's side of the bill-to party is “Unopened.”

By confirming status transitions, the accounting personnel of the biller is able to easily confirm the progress of processing made by the accounting personnel of the bill-to party. That is to say, the accounting personnel of both parties are able to confirm the current status of each invoice data in real-time.

All summaries 113c, 113d, and 113e illustrated in FIG. 7A are of invoice data D2.

When the accounting personnel of the bill-to party has viewed the invoice data D2 and selected a Confirm button (to be described later), the data processing unit 11 changes information displayed in the summary display area 113 from the summary 113c to the summary 113d on the management screen 110 of the terminal device operated by the accounting personnel of the biller.

After that, when the accounting personnel of the bill-to party has made payment for the invoice data D2 and selected a Paid button, not illustrated, the data processing unit 11 changes information displayed in the summary display area 113 from the summary 113d to the summary 113e on the management screen 110 of the terminal device operated by the accounting personnel of the biller.

As another example, both summaries 113f and 113g illustrated in FIG. 7B are of invoice data D3.

When the accounting personnel of the bill-to party has viewed the invoice data D3 and selected a Return button (to be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the contents of the invoice in the invoice display area 114. The contents of the invoice to be displayed in the invoice display area 114 are the same as those of existing (paper-based or PDF-based) invoices, except that an address display area 114a and various buttons, which will be described later, are displayed.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “returning” with respect to the invoice data being displayed in the invoice display area 114, and then changes the Status on the Other Party's Side column to “returned”. In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the biller and the bill-to party in the invoice data. Then, the data processing unit 11 stores information on the created invoice data in the invoice data management table T1. At this time, with respect to the invoice data, “Draft” is set in the Status on Personnel's Side column and a blank is set in the Status on the Other Party's Side column.

Refer back to FIG. 2.

Among all invoice data placed in the Inbox and Outbox folders, data other than deleted invoice data, invoice data saved in the archive, and invoice data in the Draft status is placed in the In and Out Box folder.

### (External Communication Button)

When the accounting personnel selects the External Communication button 115, the data processing unit 11 switches the management screen 110 into an external communication input mode. In this external communication input mode, when the accounting personnel enters text (text data) in the information input area 122 and presses the enter key of a keyboard or the like to fix this operation, the data processing unit 11 stores, as an external communication, the text data in the external communication data storage unit 13 in association with the mail address of the accounting personnel and the invoice data being displayed in the invoice display area 114.

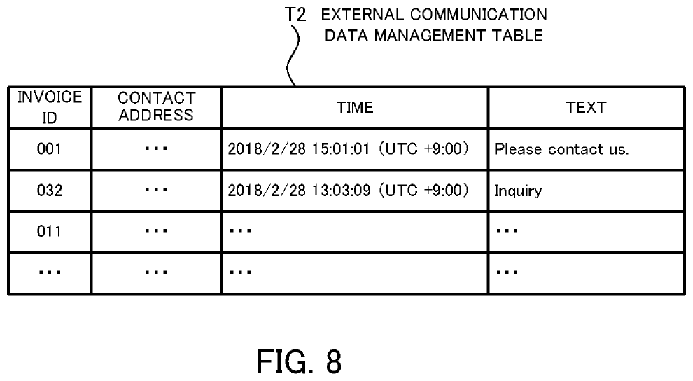

FIG. 8 is a view for explaining an example of external communication data.

In the present embodiment, external communication data is stored in tabular form.

The external communication data management table T2 has the following columns: Contact Address, Invoice ID, Time, and Text. Information pieces arranged in a horizontal direction are associated with each other.

The Invoice ID column contains the invoice ID of invoice data (invoice data associated with external communication data) that was displayed in the invoice display area 114 when the accounting personnel created the external communication data.

The Contact Address column contains the mail address of a creator that has created the external communication data.

The Time column contains the creation date and time of the external communication data.

The Text column contains the contents of the external communication.

In addition, in the external communication input mode, the data processing unit 11 refers to the external communication data management table T2 with respect to the invoice data being displayed in the invoice display area 114, and displays the external communications created so far, together with the fixed dates and times in chronological order in the information display area 121.

The information display area 121 displays external communications entered by the accounting personnel of both the sender and the recipient of the invoice data. Therefore, this external communication input mode enables these accounting personnel to perform communications like chats with each other.

In this connection, other processing (downloading, conversion to PDF format, and others) performed by the accounting personnel on the invoice data being displayed in the invoice data display area 114 may be indicated in the information display area 121 together with the execution dates and times of the processing. This enables both the accounting personnel to know the history on each other's processing.

### (Attached File Button)

When the accounting personnel selects the Attached File button 116, the data processing unit 11 switches the management screen 110 into an attached file mode. In this attached file mode, when the accounting personnel clicks and drags attached data into the information input area 112 and presses the enter key of the keyboard or the like to fix this operation, the data processing unit 11 stores the attached data in the attached file data storage unit 14 in association with the mail address of the accounting personnel and the invoice data being displayed in the invoice display area 114.

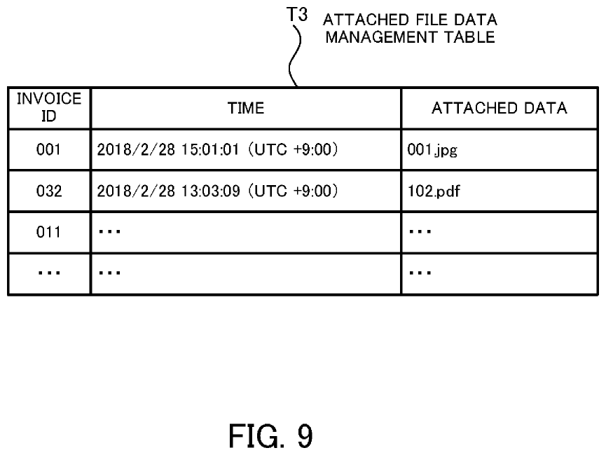

FIG. 9 is a view for explaining an example of attached file data.

In the present embodiment, attached file data is stored in tabular form.

The attached file data management table T3 has the following columns: Invoice ID, Time, and Attached Data. Information pieces arranged in a horizontal direction are associated with each other.

The Invoice ID column contains the invoice ID of invoice data (invoice data associated with attached data) that was displayed on a screen when the attached data was attached.

The Time column contains the attached date and time of the attached data.

The Attached Data column contains the name of the attached data.

In a file mode, the data processing unit 11 refers to the attached file data management table T3 with respect to invoice data being displayed in the invoice display area 114, and displays information about attached files attached so far, in chronological order in the information display area 121.

### (History Button)

The data processing unit 11 stores a history (history data) on operations made so far by the accounting personnel of both parties in the history data storage unit 15.

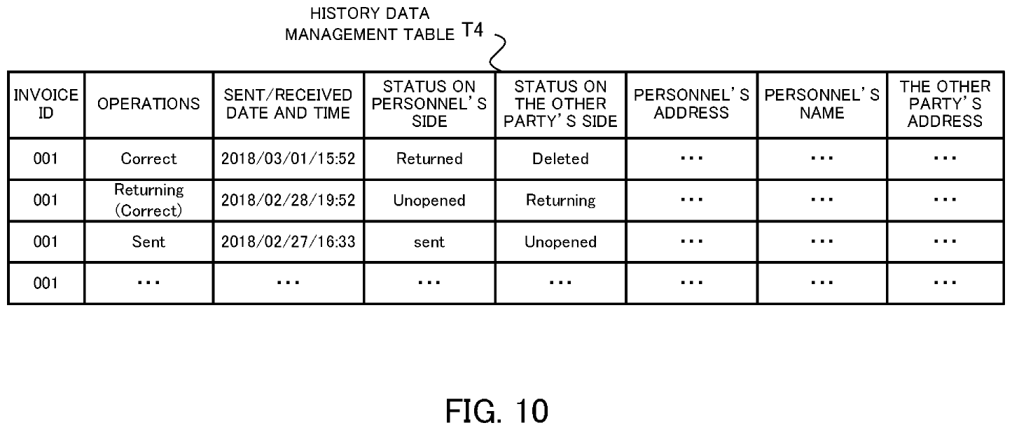

FIG. 10 is a view for explaining an example of the history data.

In the present embodiment, data is stored in tabular form.

The data processing unit 11 creates a history data management table T4 for each invoice data. In this connection, a different history data management table T4 is created for a different version.

The history data management table T4 has the following columns: Invoice ID, Operations, Send/Received Date and Time, Status on Personnel's Side, Status on the Other Party's Side, Personnel's Address, Contact Name, and The Other Party's Address. Information pieces arranged in a horizontal direction are associated with each other.

The Operations column contains an operation made by the accounting personnel. The other columns have the same contents as those of the invoice data management table T1, and therefore the description of these columns will not be repeated.

### (Memo Button)

When the accounting personnel selects the Memo button 118, the data processing unit 11 switches the management screen 110 into a memo input mode. In this memo input mode, when the accounting personnel enters letters and so on in the information input area 122 and presses the enter key of the keyboard or the like to fix this operation, the data processing unit 11 stores the letters and so on as a memo in association with the mail address of the accounting personnel and the invoice data being displayed in the invoice display area 114 in the memo data storage unit 16. This memo is viewable only by the person who created the memo.

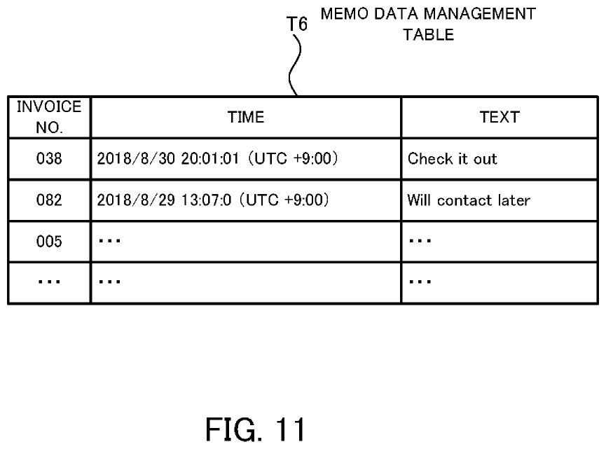

FIG. 11 is a view for explaining an example of memo data.

In the present embodiment, memo data is stored in tabular form.

The memo data management table T6 has the following columns: Invoice ID, Time, and Text. Information pieces arranged in a horizontal direction are associated with each other.

The Invoice ID column contains the invoice ID of invoice data (invoice data associated with a memo) that was displayed on a screen when the accounting personnel created the memo.

The Time column contains the creation date and time of the memo data.

The Text column contains the contents of the memo.

In addition, in the memo input mode, the data processing unit 11 accesses the memo data storage unit 16 to display memos created so far about invoice data being displayed in the invoice display area 114 in chronological order in the information display area 121.

Refer now back to FIG. 2 again.

### (External Communication List Button)

When the accounting personnel selects the External Communication List button 119, the data processing unit 11 accesses the external communication data storage unit 13 storing therein data about external communications, and displays a list screen (external communication list screen) regarding external communications about invoices handled by the accounting personnel in chronological order on the management screen 110.

### (Memo List Button)

When the accounting personnel selects the Memo List button 120, the data processing unit 11 accesses the memo data storage unit 16 storing therein data on external communications, to display a list screen (memo list screen) of memos regarding invoices handled by the accounting personnel in chronological order on the management screen 110.

Refer now back to FIG. 4.

The transaction data generation unit 17 collects transaction data stored so far in the storage units 12 to 16 when the transaction data is updated a prescribed number of times, adds a cryptographic signature to the transaction data, and sends the resultant to the databases 3a, 3b, and 3c that perform consensus building. In this connection, the transaction data includes at least one of invoice data, the status of invoice data, external communication data, attached file data, history data, and memo data.

More specifically, the transaction data generation unit 17 has two counters. The transaction data generation unit 17 increments one (first counter) of the counters by one each time a status indicating the processing progress of invoice data communicated between an issuer and a recipient is changed.

In addition, the transaction data generation unit 17 increments the other counter (second counter) by one each time the external communication data, attached file data, or memo data accompanying the invoice data is changed.

The transaction data generation unit 17 determines whether either of the first and second counters has reached a value indicating a prescribed number of times. When the value of either counter indicates the prescribed number of times, the transaction data generation unit 17 sends a block that is a collection of the transaction data stored so far to the databases 3a, 3b, and 3c. Then, the transaction data generation unit 17 resets the value of the counter that indicates the prescribed number of times.

The following describes functions of the databases 3a, 3b, and 3c.

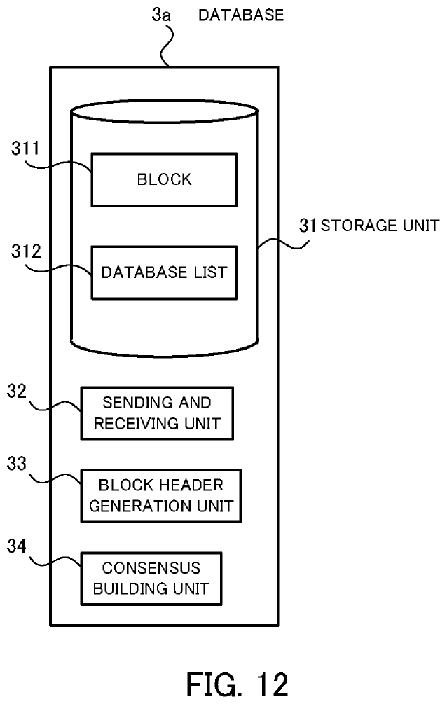

FIG. 12 is a block diagram for explaining functions of a database according to the embodiment.

The database 3a includes a storage unit 31, a sending and receiving unit 32, a block header generation unit 33, and a consensus building unit 34.

The storage unit 31 stores a block 311 and a database list 312. Needless to say, information stored in the storage unit 31 is not limited to these.

The block 311 is generated by appending information needed for creating a blockchain to a bunch (transaction) of information to be registered in the blockchain, such as an individual transaction history or a collection of information on processing of a computer.

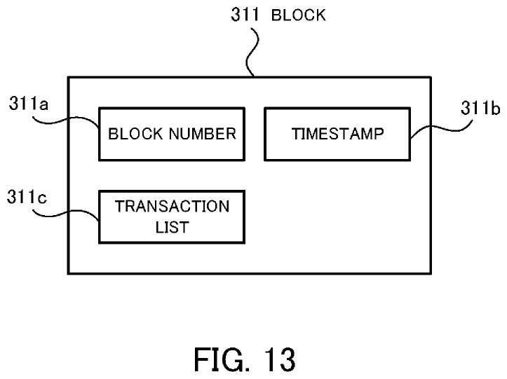

FIG. 13 illustrates an example of information contained in a blockchain according to the embodiment.

The block 311 contains a block number 311a, a timestamp 311b, and a transaction list 311c.

The block number 311a is information identifying the block 311.

The timestamp 311b is a timestamp of a newly created block.

The transaction list 311c means a transaction history or a collection of information on processing of a computer. Here, the transaction list 311c is a list of information to be registered in a blockchain. More specifically, the transaction list 311c includes external communication data, attached file data, history data, and memo data.

The database list 312 is a list of identification information (for example, IP addresses) identifying the other databases connected to the blockchain network 20.

The transmitting and receiving unit 32 receives data (record data) to be recorded in the block 311 from the invoice management apparatus 1.

The block header generation unit 33 generates a hash value by applying a hash function to the record data.

In addition, the block header generation unit 33 generates a block header using the generated hash value, the hash value of a previous block, and the timestamp 311b.

The consensus building unit 34 applies an appropriate value to “Nonce” generated by the block header generation unit 33 to calculate a hash value for the block header.

A database (here, the database 3a) that is the first that has found a solution out of the databases 3a, 3b, and 3c notifies the databases 3b and 3c of the solution finding. Each database 3b and 3c adds the received block to their own exiting blocks. By doing so, the consistency of transaction data is ensured among the databases 3a, 3b, and 3c.

As described above, in the invoice management system 10, the invoice management apparatus 1 includes the invoice data storage unit 12 that stores therein, upon receipt of invoice data addressed to a specified recipient from a terminal device 2a, 2b, 2c over a network, the received invoice data in association with the identification information of the recipient and the identification information of the issuer of the invoice data, and a transaction data generation unit 17 that determines whether at least one of the number of times a status indicating the processing progress of business document data communicated between an issuer and a recipient has been changed and the number of times data accompanying the business document data has been changed has reached a prescribed number of times, and when the prescribed number of times has been reached, collects the invoice data and data accompanying the invoice data and sends the collected data to the databases 3a, 3b, and 3c that perform consensus building.

That is, the consensus building is performed when the status of the invoice data is changed or when data accompanying the invoice data is changed. This makes it possible to prevent the invoice data and data accompanying the invoice data from being falsified and to ensure the consistency of the invoice data.

In addition, the invoice management apparatus 1 may be configured to have the functions of the databases 3a, 3b, and 3c.

Note that invoice data is not communicated directly between the terminal devices 2a, 2b, and 2c. The invoice data created using the terminal devices 2a, 2b, and 2c and sent to bill-to parties is held by the invoice management apparatus 1 and is treated like shared data. Therefore, the accounting personnel of a bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

The information display area 121 displays external communications made by the accounting personnel of both the sender and the recipient of invoice data. Therefore, using the external communication input mode enables the accounting personnel of both parties to perform communications like chats.

Information on invoice data is stored in the invoice data management table T1 when the invoice data is sent, and the statuses of subsequent transactions are managed using this invoice data management table T1. Therefore, the accounting personnel is able to get away from manually compiling invoices into a data sheet.

Note that the processing performed by the invoice management apparatus 1 may be performed in a distributed manner by a plurality of apparatuses.

In addition, in the embodiment, the invoice management apparatus 1 is provided with various storage units including the invoice data storage unit 12. The embodiment is not limited thereto, and cloud storage may be provided, instead of the various storage units, at a location different from the data processing unit 11.

Heretofore, the information processing apparatus and information processing method of the present invention have been described in the embodiment illustrated. The invention is not limited thereto, and the components of each unit may be replaced with other components having equivalent functions or other components. In addition, other desired configurations and steps may be added.

Further, two or more desired configurations (features) in the above-described embodiment may be combined.

The above-described processing functions may be implemented by using a computer. In this case, a program is prepared, which describes processes for the functions of the invoice management apparatus 1. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, flexible disks (FDs), magnetic tapes, etc. The optical discs include DVDs, DVD-RAMs, CD-ROMs, CD-RWs, etc. The magneto-optical recording media include MOs (magneto-optical disks), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to ensure the consistency of business document information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory that stores therein, upon receipt of business document data addressed to a specified recipient from a terminal device over a network, the received business document data in association with identification information of the recipient and identification information of an issuer of the business document data; and
a processor that is coupled to the memory and is configured to perform a process including,
determining whether at least one of a number of times a status indicating a processing progress of the business document data communicated between the issuer and the recipient has been changed and a number of times data accompanying the business document data has been changed has reached a prescribed number of times, and
collecting, in response to the prescribed number of times having been reached, the business document data and the data accompanying the business document data and sending the collected business document data and data to a plurality of consensus building devices that perform consensus building.

2. The information processing apparatus according to claim 1, wherein
the business document data is invoice data, and
the status is changed at at least one of first to third times, the first time being when the recipient has confirmed the invoice data, the second time being when the recipient has paid an amount indicated in the invoice data, the third time being when the issuer has confirmed a payment of the amount.

3. The information processing apparatus according to claim 1, wherein
changes of the data accompanying the business document data include at least one of communication of the business document data between the recipient and the issuer over the network, writing of a memo regarding the business document data by the recipient or the issuer, and attachment of data to the business document data.

4. A consensus building method comprising:
storing, upon receipt of business document data addressed to a specified recipient from a terminal device over a network, by a computer, the received business document data in association with identification information of the recipient and identification information of an issuer of the business document data;
determining, by the computer, whether at least one of a number of times a status indicating a processing progress of the business document data communicated between the issuer and the recipient has been changed and a number of times data accompanying the business document data has been changed has reached a prescribed number of times; and
collecting, in response to the prescribed number of times having been reached, by the computer, the business document data and the data accompanying the business document data and sending the collected business document data and data to a plurality of consensus building devices that perform consensus building.

5. A non-transitory computer-readable storage medium storing a computer program that causes a computer to perform a process comprising:
storing, upon receipt of business document data addressed to a specified recipient from a terminal device over a network, the received business document data in association with identification information of the recipient and identification information of an issuer of the business document data;
determining whether at least one of a number of times a status indicating a processing progress of the business document data communicated between the issuer and the recipient has been changed and a number of times data accompanying the business document data has been changed has reached a prescribed number of times; and
collecting, in response to the prescribed number of times having been reached, the business document data and the data accompanying the business document data and sending the collected business document data and data to a plurality of consensus building devices that perform consensus building.
